(19) United States
(12) Patent Application Publication
(10) Pub. No.: US 2025/0277583 A1
(43) Pub. Date: Sep. 4, 2025

(54) LOW TEMPERATURE HOMOGENEOUS CHARGE CONTINUOUS OXIDATION BURNER HEAT SOURCE

(71) Applicant: Red Leaf Resources, Inc., Salt Lake City, UT (US)

(72) Inventors: James Patten, Sandy, UT (US); James Bunger, Salt Lake City, UT (US); John Faull, Salt Lake City, UT (US)

(21) Appl. No.: 19/043,684

(22) Filed: Feb. 3, 2025

Related U.S. Application Data
(60) Provisional application No. 63/549,264, filed on Feb. 2, 2024.

(51) Int. Cl. F23C 99/00

(52) U.S. Cl. CPC F23C 99/006; F23C 2900/99001

(57) ABSTRACT

A homogeneous charge continuous oxidation system for generating heat can include a fuel gas source, an oxygen source, and a carbon dioxide source. The oxygen source can include oxygen gas that is substantially free of nitrogen or that contains nitrogen in an amount less than 10 vol %. The system can also include an oxidation chamber including an oxidation product outlet and at least one inlet connected to the fuel gas source, the oxygen source, and the carbon dioxide source to receive a gas mixture of fuel gas, oxygen, and carbon dioxide. A body of porous material can be within the oxidation chamber and positioned in a flow path of the gas mixture between the at least one inlet and the oxidation product outlet such that oxidation occurs within the body of porous material.

### CROSS REFERENCE TO RELATED APPLICATIONS

This application claims priority to U.S. Provisional Patent Application No. 63/549,264 filed Feb. 2, 2024, which is hereby incorporated by reference.

### BACKGROUND

Burning combustible gases, including hydrocarbons, hydrogen, and carbon monoxide, is typically accomplished with air as an oxygen source. The oxidation temperature in these processes is often managed using excess air (nitrogen in the air does not participate in oxidation and therefore absorbs heat and limits local temperature) in order to accommodate materials properties of the burner construction and temperature requirements of the materials of construction of the process equipment that the heat source supports. In addition, mixing of fuel and air in typical burners produces an inhomogeneous mixture such that some regions are much higher temperature than others. The combination of the presence of nitrogen (a component of the air) and local inhomogeneities results in three undesirable effects. High local temperatures and the presence of nitrogen directly results in the generation of prompt oxides of nitrogen (NOₓ), a regulated emission. In addition, all products of oxidation (oxidation) with air result in emissions containing nitrogen (N₂), which must be removed (separated) in order to capture and store or make beneficial use of the produced CO₂. This separation of nitrogen from CO₂ can be expensive and energy intensive, but is increasingly done in order to capture and store of CO₂ due to climate issues. This is supported by increasing regulation and mandate structure and related incentives. Also, high local temperatures can dictate more temperature tolerant and therefore more expensive materials of construction and can adversely affect service life.

### SUMMARY

The present technology involves homogeneous charge continuous oxidation systems and methods for generating heat. In one example, a system includes a fuel gas source, an oxygen source, and a carbon dioxide source. The oxygen source can comprise oxygen gas that is substantially free of nitrogen or that comprises nitrogen in an amount less than 10 vol %. An oxidation chamber can include an oxidation product outlet and at least one inlet connected to the fuel gas source, the oxygen source, and the carbon dioxide source to receive a gas mixture of fuel gas, oxygen, and carbon dioxide. A body of porous material can be within the oxidation chamber and positioned in a flow path of the gas mixture between the at least one inlet and the oxidation product outlet such that oxidation occurs within the body of porous material.

In another example, a homogeneous charge continuous oxidation method for generating heat can include flowing a gas mixture through a body of porous material within an oxidation chamber. The gas mixture can comprise a fuel gas, oxygen, and carbon dioxide, and the oxygen can be provided from an oxygen source that is substantially free of nitrogen or that comprises nitrogen in an amount less than 10 vol %. The body of porous material can be maintained at a temperature above an oxidation initiation temperature of the gas mixture. The gas mixture can be oxidized within the body of porous material, thereby generating heat and oxidation products. The oxidation products can flow out of the oxidation chamber.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic view of an example homogeneous charge continuous oxidation system for generating heat, in accordance with an example of the present technology.

FIG. 2 is a schematic view of another example homogeneous charge continuous oxidation system for generating heat, in accordance with an example of the present technology.

FIG. 3 is a schematic view of another example homogeneous charge continuous oxidation system for generating heat, in accordance with an example of the present technology.

FIG. 4 is a schematic view of yet another example homogeneous charge continuous oxidation system for generating heat, in accordance with an example of the present technology.

FIG. 5 is a schematic view of still another example homogeneous charge continuous oxidation system for generating heat, in accordance with an example of the present technology.

FIG. 6 is a schematic view of another example homogeneous charge continuous oxidation system for generating heat, in accordance with an example of the present technology.

FIG. 7 is a schematic view of yet another example homogeneous charge continuous oxidation system for generating heat, in accordance with an example of the present technology.

FIG. 8 is flowchart illustrating an example homogeneous charge continuous oxidation method for generating heat, in accordance with an example of the present technology.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural references unless the context clearly dictates otherwise. Thus, for example, reference to “a chamber” includes reference to one or more of such systems and reference to “the inlet” refers to one or more of such devices.

As used herein with respect to an identified property or circumstance, “substantially” refers to a degree of deviation that is sufficiently small so as to not measurably detract from the identified property or circumstance. The exact degree of deviation allowable may in some cases depend on the specific context. The term “substantially free of nitrogen” and “substantially free of nitrogen compounds” is used herein to describe gases that include no nitrogen or nitrogen compounds, or less than about 2 vol % nitrogen or nitrogen compounds.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” and “at least one of A, B, or C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Homogeneous Charge Continuous Oxidation Systems

The present technology provides Homogeneous Charge Continuous Oxidation (HCCO) oxyfueled (i.e., utilizing pure oxygen or above about 90 vol % oxygen instead of air) burner designs to produce heat from combustible gases. The combustible gases can include a mixture of fuel gas, recycled gas and high concentration oxygen. The oxidation can produce CO₂ that is ready for storage or beneficial use without further separation energy requirements or costs. The systems and methods described herein can utilize utilizes CO₂ instead of N₂ to attenuate the temperature. In addition, the temperature of oxidation can be uniform and the ratios of oxygen, fuel and CO₂ can be independently controlled to control the temperature over a wide range to support various process and materials requirements.

The oxygen-fueled combustible gaseous fuel burners described herein can produce high temperature process gas controlled precisely to a uniform desired temperature from about 700° F. (371° C.) to on the order of 3,000° F. (1649° C.). The burner can also produce concentrated carbon dioxide in a gas stream free of nitrogen. This can be used for heat supplied to industrial processes while minimizing process equipment materials costs (along with reducing downtime and, consequently, operational costs) and eliminating energy consumption and costs associated with carbon dioxide separation from the exhaust stream. The technology can also eliminate the production of NOₓ in the oxidation process.

In one example, a homogeneous charge continuous oxidation system for generating heat can include a fuel gas source, an oxygen source, and a carbon dioxide source. The oxygen source can comprise oxygen gas that is substantially free of nitrogen or less than 10 vol % nitrogen, in some cases less than 5 vol % and in other cases less than 2 vol % nitrogen. The system can also include an oxidation chamber including an oxidation product outlet and at least one inlet connected to the fuel gas source, the oxygen source, and the carbon dioxide source to receive a gas mixture of fuel gas, oxygen, and carbon dioxide. A body of porous material can be within the oxidation chamber and positioned in a flow path of the gas mixture between the at least one inlet and the oxidation product outlet such that oxidation occurs within the body of porous material.

In some examples, the flow of fuel gas, oxygen, and carbon dioxide can be independently controllable. The fuel can include a hydrocarbon, and in some cases can be substantially free of nitrogen compounds. In certain examples, the fuel gas can include natural gas, methane, hydrogen, hydrocarbons produced from oil shale, or a combination thereof. As used herein, gaseous fuels or fuel gas refer to both fuels that are gasses under ambient conditions, such as natural gas, synthesis gas, hydrogen, refinery gas, and other gaseous fuels, as well as vaporized fuels that are liquid under ambient conditions, including gasoline, diesel fuel, jet fuel, JP-4, JP-8, fuel oil, bunker fuel, and other vaporized liquid fuels. The oxygen source can include an oxygen concentrator configured to separate oxygen from air.

The system can also include a carbon dioxide recycle stream connected to the oxidation product outlet. The carbon dioxide source can include recycled carbon dioxide produced from oxidation in the oxidation chamber and recycled through the recycle stream. In some cases, the carbon dioxide source can also include unburned fuel gas recycled through the carbon dioxide recycle stream. The system can also include a carbon dioxide sequestration stream connected to the oxidation product outlet and configured to sequester carbon dioxide produced by the oxidation.

In further examples, the system can include a preheater configured to preheat at least one of the fuel gas, oxygen, and carbon dioxide upstream of the body of porous material. The system can also include a gas mixing chamber connected downstream of the fuel gas source, oxygen source, and carbon dioxide source, and upstream of the oxidation chamber. The gas mixing chamber can be configured to prepare a homogeneous mixture of fuel gas, oxygen, and carbon dioxide before the gas mixture flows into the oxidation chamber. In some examples, the flow path of the gas mixture can be in a downward direction, while in other examples the flow path can be in an upward direction.

The porous material can substantially fill the oxidation chamber. The porous material can include a loose particulate material. The porous material can have an average particle size from about 1 mm to about 20 cm. In certain examples, the porous material can include spent oil shale, rock, alumina beads, metal beads, metal balls, zeolite, ceramic, or a combination thereof. In other examples, the porous material can include structured packing, metal screen, ceramic screen, baffles, mesh, or a combination thereof.

The system can also include a heat exchanger connected downstream to the oxidation product outlet, where the heat exchanger can provide heat to an industrial process. In certain examples, the system can also include an oil shale pyrolyzing unit connected downstream to the oxidation product outlet, and the oxidation products can provide heat to pyrolyze oil shale.

The present disclosure also describes methods of generating heat. In one example, a homogeneous charge continuous oxidation method for generating heat can include flowing a gas mixture through a body of porous material within an oxidation chamber. The gas mixture can include a fuel gas, oxygen, and carbon dioxide, and the oxygen can be provided from an oxygen source that is substantially free of nitrogen or less than 10 vol % nitrogen. The body of porous material can be maintained at a temperature above an oxidation initiation temperature of the gas mixture. The gas mixture can be oxidized within the body of porous material, thereby generating heat and oxidation products. The oxidation products can flow out of the oxidation chamber.

In some examples, the method can include independently controlling a concentration of fuel gas, oxygen, and carbon dioxide in the gas mixture. The fuel gas can include a hydrocarbon, and in certain examples can include natural gas, methane, hydrogen, hydrocarbons produced from oil shale, or a combination thereof. In further examples, the method can include separating the oxygen from air and mixing the oxygen with the fuel gas and the carbon dioxide. The carbon dioxide can include recycled carbon dioxide produced from oxidation in the oxidation chamber. The certain examples, the gas mixture can be fuel-rich. Additionally, the fuel gas can include recycled unburned fuel gas from the oxidation chamber. The method can also include sequestering carbon dioxide from the oxidation products.

The method can also include preheating the gas mixture before the gas mixture contacts the body of porous material. In some examples, the gas mixture can be preheated to a preheat temperature within 50° F. (28° C.) of an oxidation initiation temperature of the gas mixture. The method can also include preparing the gas mixture by mixing the fuel gas, oxygen, and carbon dioxide. The gas mixture can be prepared in a gas mixing chamber that is upstream of the oxidation chamber. In other examples, the gas mixture can be prepared in the oxidation chamber by flowing the fuel gas, oxygen, and carbon dioxide into the oxidation chamber as multiple separate streams and then mixing the fuel gas, oxygen, and carbon dioxide inside the oxidation chamber. In some examples, the gas mixture can flow through the body of porous material in a downward direction. In other examples, the gas mixture can flow through the body of porous material in an upward direction.

The porous material can substantially fill the oxidation chamber. In some examples, the porous material can be a loose particulate material. The porous material can have an average particle size from about 1 mm to about 20 cm. In certain examples, the porous material can include spent oil shale, rock, alumina beads, metal balls, metal beads, zeolite, ceramic, or a combination thereof. In other examples, the porous material can include structured packing, metal screen, ceramic screen, baffles, mesh, or a combination thereof.

The method can also include providing heat from the oxidation products to an industrial process connected downstream of the oxidation chamber. In certain examples, the heat can be used to pyrolyze oil shale. The method can also include controlling a temperature of oxidation in the oxidation chamber by adjusting a concentration of carbon dioxide in the gas mixture. In some examples, the oxidation temperature in the oxidation chamber can be from about 700° F. (371° C.) to about 3,000° F. (1649° C.).

In some cases, a ratio of fuel gas to oxygen in the gas mixture can be about a stoichiometric ratio for oxidation. In other examples, the ratio of fuel gas to oxygen in the gas mixture can be sub-stoichiometric with respect to oxygen. The concentration of oxygen in the gas mixture can be 10 vol % or less. In certain examples, the gas mixture can include oxygen at a concentration from 0.1 vol % to 10 vol %, fuel gas at a concentration from 5 vol % to 70 vol %, and carbon dioxide at a concentration from 25 vol % to 90 vol %.

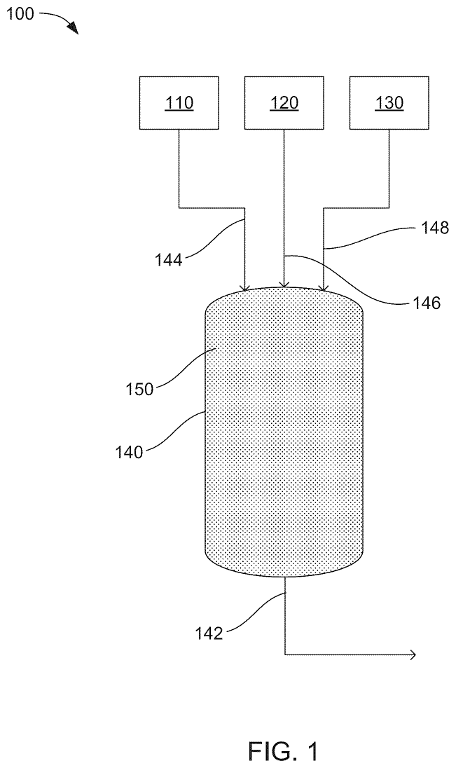

FIG. 1 shows one example homogeneous charge continuous oxidation system for generating heat 100. This system includes a fuel gas source 110, an oxygen source 120, and a carbon dioxide source 130. The oxygen source can provide oxygen gas that is substantially free of nitrogen. The system also includes an oxidation chamber 140 that has an oxidation product outlet 142, a fuel gas inlet 144, an oxygen inlet 146, and a carbon dioxide inlet 148. Thus, in this example, the fuel gas, oxygen, and carbon dioxide flow into the oxidation chamber and then mix inside the oxidation chamber. A body of porous material 150 is within the oxidation chamber. The body of porous material is within the oxidation chamber and positioned in a flow path of the gas mixture so that oxidation of the gas mixture occurs within the body of porous material.

The gas mixture that is combusted in the oxidation chamber can include fuel, oxygen, and carbon dioxide. The carbon dioxide can act as a diluent in place of the more commonly used nitrogen. The gas mixture can be substantially free of nitrogen or can have reduced nitrogen. The oxygen can be provided from a source of pure oxygen or enriched oxygen instead of using normal air in the gas mixture to provide the oxygen. In certain examples, the oxygen can be provided by an oxygen generator or oxygen concentrator that separates oxygen from air. In some cases, a reduced amount of residual nitrogen may be present in an enriched oxygen stream provided by an oxygen concentrator. Therefore, the gas mixture may not be entirely nitrogen-free, but may contain a reduced amount of nitrogen compared to a mixture that utilizes normal air for the oxygen. In some examples, the oxygen that is used in the gas mixture can be 90 vol % pure or greater, and may contain up to 10 vol % nitrogen. However, in other examples, the oxygen can be nitrogen-free, which can allow for the elimination of NOₓ in the exhaust. In further examples, the oxygen can be provided from any other source of pure oxygen, such as a compressed oxygen tank, liquid oxygen, oxygen produced from electrolysis of water, or others. In further examples, the fuel gas can also be substantially free of nitrogen gas and nitrogen compounds that would potentially form NOₓ upon oxidation.

The fuel gas can include a hydrocarbon gas. In certain examples, the fuel gas can include natural gas, methane, hydrogen, hydrocarbons produced from oil shale, or a combination thereof. Other hydrocarbon gases can include ethane, propane, acetylene, and others. Natural gas can be obtained from a natural gas pipeline, produced gas from an oil or gas field, or other natural gas sources. The fuel gas can also include recycled unburned fuel gas that has already passed through the oxidation chamber in some examples. In some cases, the stream of fuel gas may not be purely fuel gas, but may also include CO₂, water, hydrogen, carbon monoxide, SOₓ, and other components.

The carbon dioxide can be provided from a variety of sources, including exhaust from a separate process, recycled exhaust from the oxidation chamber, pure carbon dioxide from a compressed gas cylinder, and so on. When the system described herein is operating at steady state, the system can produce a surplus of carbon dioxide. Therefore, in some examples, substantially all of the carbon dioxide that is included in the gas mixture injected into the oxidation chamber can be recycled carbon dioxide from the oxidation chamber. Surplus carbon dioxide can be sequestered or stored in some examples. In some cases, another source of carbon dioxide may be used during startup until the system is at steady state and provides a sufficient amount of recycled carbon dioxide.

The composition of the gas mixture can be adjusted by controlling the concentration of fuel gas, oxygen, and carbon dioxide in the gas mixture. In some cases, this can be accomplished by controlling the flow rates of these gases from the fuel gas source, the oxygen source, and the carbon dioxide source. The system can include control valves in some examples to allow the flow rates of these gases to be independently controlled. The system can also include flow rate sensors and optionally an electronic controller connected to the flow rate sensor and control valves to provide automated control of the flow rates.

In some examples, the system can be divided into an upstream fuel preparation section and a downstream heat production section. The upstream fuel preparation section can include provision for combining/mixing fuel gas and pure oxygen. The mixture can be diluted with recycled CO₂. As a general guideline, the dilution carbon dioxide acts as a heat carrier. For example, if there were no CO₂, the amount of oxygen added to maintain a temperature of 700° F. (371° C.) would be minuscule such that no heating work would be done. Dilution also allows balance with fuel to avoid explosive conditions during initial mixing.

The downstream heat production section can include the oxidation chamber containing a porous array of particulate material. The body of particulate material can have interconnected continuous porosity to allow the gas mixture to flow through the body of porous material. The porous material can be a solid that provides a site for retention of oxidation heat and continuous homogeneous oxidation of the fuel gas. This section can homogenize the composition of gas mixtures flowing from the upstream fuel preparation section and homogenize the temperature of gases flowing through this section and undergoing oxidation and heat generation. The porous array of particulate material can include spent oil shale, rock, alumina beads, metal beads, metal balls, zeolite, ceramic, structured packing, metal screen, ceramic screen, baffles, mesh, or a combination thereof.

In some examples of the present invention, a sub-stoichiometric amount of oxygen can be used during oxidation to limit the oxidation temperature (e.g. to avoid high temperature oxidation). This can provide hot oxidation product gases at a lower temperature, which can be more suitable for specific thermal process requirements. Additionally, the oxygen can be depleted during oxidation so that downstream processes and/or downstream materials of construction are not degraded by excess oxygen. Gaseous mixtures of fuel, oxygen, and non-participating constituents will begin to oxidize at a meaningful rate at a minimum oxidation temperature based on achieving rates to completion within the residence time in the oxidation chamber. Above such minimum temperature, increasing oxygen concentration will release increasing heat and combined with the heat capacity properties of the gaseous mixture, will result in a higher temperature. In some examples, the amount of heat released in the oxidation chamber can be approximately proportional to the amount of oxygen introduced into the oxidation chamber. For example, some hydrocarbon fuel gases can produce about 5,500 BTU per pound of oxygen. Therefore, the temperature in the oxidation chamber can be calculated using the amount of oxygen and other gases present in the oxidation chamber, the initial temperatures of the gases, and the heat capacities of the gases.

In some examples, a well-mixed (homogeneous) gaseous mixture of oxygen, hydrocarbons and other combustible gases, and oxidation products including carbon dioxide, can flow into the oxidation chamber. The gaseous mixture can contact a body of porous material. The porous material can be temperature resistant, oxidation resistant, thermally stable, and have a high heat capacity. The porous material can be at a temperature above the oxidation temperature of the gaseous mixture. This can initiate the Homogeneous Charge Continuous Oxidation (HCCO) process. In some cases, the porous material in this oxidation zone of the oxidation chamber can be initially preheated by conventional oxidation upstream in the oxidation chamber, or by externally heated gasses introduced into the oxidation chamber, or by direct or indirect resistance or radiant heating of the porous material, etc. In certain examples, preheating the porous material can be performed only until the HCCO process is initiated. As the gaseous mixture contacts and passes through this hot porous material it can absorb heat and approach temperatures at which kinetically meaningful oxidation can occur (HCCO), referred to herein as the ‘oxidation temperature’. As used herein, “oxidation temperature” refers to a temperature at which the rate of oxidation is faster than the residence time of the mixture. Oxidation can begin in this zone, and the oxidation reaction can provide heat to continuously keep the temperature in this zone within an oxidation temperature range for the gaseous mixture until all oxygen is consumed. This zone can be referred to as the oxidation zone (HCCO zone). If sufficient oxygen is provided, this oxidation zone can remain sufficiently hot to initiate oxidation and accomplish complete consumption of oxygen in the fuel gas and oxygen mixture in this oxidation zone. The gas stream emerging from the HCCO burner (hot process gas) can be extremely uniform in temperature, completely free of oxygen, completely free of nitrogen, completely free of NOₓ and can be managed from very low temperature (on the order of 700° F. (371° C.)) to near stoichiometric temperatures (on the order of 3,000° F. (1649° C.)).

When the amount of oxygen in the gas mixture is sub-stoichiometric for oxidation of the fuel gas, the oxidation product stream can be rich in unburned fuel. The oxidation product stream can be used to provide heat to another process, and then the stream can still contain the combustible fuel. Some of this stream can be returned to the HCCO burner (oxidation chamber) as a recycle stream for continued HCCO burner operation. Additional fresh fuel can be added to the recycle stream and oxygen can also be added as described above to support oxidation. Another part of the fuel-rich oxidation product stream can be provided to a power generation unit that can be oxyfueled (pure oxygen or at least 90 vol % oxygen rather than air to support oxidation) to provide a net system output of pure CO₂ and water, suitable for direct storage or application to enhanced oil recovery (EOR) or other CO₂ applications.

In certain examples, the recycle stream can include unburned hydrocarbons, hydrogen, CO₂, CO, H₂O, H₂S, and SOₓ. If excess oxygen was used during oxidation, then the recycle stream can include oxygen. As mentioned above, in some cases the amount of oxygen introduced to the HCCO burner can be limited to a sub-stoichiometric amount so that the oxidation temperature is lower than it would be with stoichiometric or excess oxygen. Oxidation temperature can also be moderated by the flowrate of the fuel gas and the carbon dioxide. When sub-stoichiometric oxygen is used, the total heat produced can be a direct function of the total oxygen provided. All available oxygen can be consumed by the oxidation occurring in the oxidation zone of the HCCO burner so that no more oxidation occurs downstream of the oxidation zone.

The oxidation temperature can be controlled by adjusting the concentration of oxygen and carbon dioxide in the gas mixture that is fed to the oxidation chamber. The quantity of heat produced at any desired temperature can also be controlled by the amount of oxygen added to the gas mixture. The concentration of oxygen can be maintained at a sub-stoichiometric concentration, which can result in an oxidation temperature that is below a normal stoichiometric oxidation temperature. The term “stoichiometric concentration” refers to a concentration of oxygen that would allow the unburned hydrocarbons and other combustible components in the fuel gas to completely oxidize in the oxidation zone oxygen, without leaving any excess oxygen. With a sub-stoichiometric concentration of oxygen, the oxidation temperature can be controlled from about 700° F. (371° C.) to in excess 3,000° F. (1649° C.). In all cases, temperature can be controlled within less than 5° F. (3° C.) of a desired temperature based on downstream process requirements and vessel material limitations. Further, below about 5% oxygen by volume, backflashes and uncontrolled oxidation can be avoided.

By controlling the total heat (BTU/time) delivered to the downstream process with the quantity of oxygen added to the stream, and the temperature of the stream by the quantity of diluting carbon dioxide added to that stream, the operator has a degree of control that is not existent when using air as the source of oxygen. Thus, the system allows for independent control of temperature and heat.

Hot process gas is generated in the oxidation zone of the HCCO burner. The hot process gas can include oxidation products and unburned hydrocarbons and other combustible fuel gasses, such as hydrogen and CO and H₂S. In a typical example, all oxygen can be substantially consumed in the oxidation zone, so that the process gas flowing downstream from the oxidation zone is oxygen-free. Unburned combustible gases (including hydrocarbons, and some CO, H₂ and H₂S) can remain in the hot process gas. However, heating value of unburned hydrocarbons in the stream exiting the HCCO burner (hot process gas) will be less than in the input to the HCCO burner.

The specific composition of the gas mixture can vary. In one example, the fuel gas is substantially free of nitrogen. In another example, the inlet oxygen concentration is non-zero and less than 5% by volume such that oxygen is a limiting reagent for oxidation so as to also maintain the low oxidation temperature. Maintaining a significant oxygen deficit also keeps the temperature in the oxidation zone well below typical oxidation temperatures of up to 5,000° F. (2760° C.) since limited oxidation can only heat the surrounding gas to a limited temperature. In this manner, the oxidation zone temperature can be carefully controlled by limiting oxygen concentrations and inlet flow rates.

In some examples, the gas mixture that flows into the oxidation chamber can include oxygen at a concentration from 0.1 vol % to 10 vol %, fuel gas at a concentration from 5 vol % to 70 vol %, and carbon dioxide at a concentration from 25 vol % to 90 vol %. These concentrations can refer to the total amount of each component in the gas mixture, no matter what input streams the components originate from. Thus, if fuel gas originates from a stream of fresh fuel gas and from a recycle stream, then the concentration described above can refer to the total concentration including fuel gas from both of these streams. In certain examples, the amount of oxygen, fuel gas, and carbon dioxide can be selected to be below a lower explosive level of the gas mixture. In further examples, the concentration of oxygen in the gas mixture can be from 0.1 vol % to 5 vol %, or from 0.1 vol % to 3 vol %, or from 0.1 vol % to 2 vol %, or from 0.1 vol % to 1 vol %, or from 1 vol % to 5 vol %, or from 2 vol % to 5 vol %, or from 3 vol % to 5 vol %. The concentration of fuel gas can be from 5 vol % to 50 vol %, or from 5 vol % to 25 vol %, or from 5 vol % to 15 vol %, or from 15 vol % to 70 vol %, or from 25 vol % to 70 vol %, or from 50 vol % to 70 vol %. The concentration of carbon dioxide can be from 25 vol % to 75 vol %, or from 25 vol % to 50 vol %, or from 50 vol % to 90 vol %, or from 75 vol % to 90 vol %, or from 50 vol % to 75 vol %.

The porous material in the oxidation chamber can be any solid material that can withstand the oxidation temperatures and which can allow the gas mixture to flow through the body of porous material. It is noted that the term “porous” does not necessarily mean that the material includes discrete holes or pores, although some examples can include discrete pores formed in the material. The porous material can include particulate materials where the individual particles of the material may not be porous, but the overall body of material is porous because there are void spaces between the individual particles of material. The gas mixture can flow through the void spaces. Some examples of particulate porous materials include spent oil shale, rock, alumina beads, metal beads, metal balls, zeolite, ceramic, and combinations thereof. In certain examples, the porous material can be a particulate material with an average particle size from about 1 mm to about 20 cm, or from 1 mm to 10 cm, or from 1 mm to 5 cm, or from 1 mm to 1 cm, or from 1 cm to 20 cm, or from 1 cm to 10 cm, or from 1 cm to 5 cm, or from 5 cm to 20 cm, or from 5 cm to 10 cm, or from 10 cm to 20 cm. In other examples, the porous material can include fibers or structured materials. Some additional examples of porous materials include metal screen, ceramic screen, baffles, mesh, and combinations thereof.

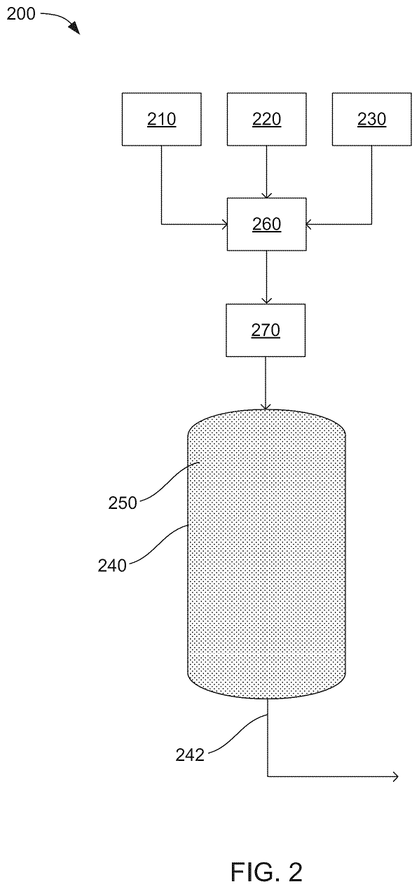

FIG. 2 shows another example homogeneous charge continuous oxidation system for generating heat 200. This example includes a fuel gas source 210, an oxygen source 220, and a carbon dioxide source 230. The fuel gas, oxygen, and carbon dioxide flow from these gas sources to a mixing chamber 260. The gases mix to form a gas mixture, which then flows through a gas preheater 270 to preheat the gas to a preheat temperature that is below the oxidation temperature. The preheated gas then flows into the oxidation chamber 240. The gas mixture flows through the body of porous material 250 and oxidation of the fuel gas occurs within the body of porous material. The oxidations products flow out through an oxidation product outlet 242.

In some examples, preheating the gas mixture can help maintain the body of porous material at the desired oxidation temperature. The gas mixture can be constantly flowing through the body of porous material. To ensure that the porous material does not become progressively cooler over time due to the cooling effect of the gas mixture prior to oxidation, the gas mixture can be preheated to a preheat temperature that is close to the oxidation temperature but less than the oxidation temperature. In some examples, the preheat temperature can be within 50° F. (28° C.) below the oxidation, or within 40° F. (22° C.) below the oxidation temperature, or within 30° F. (17° C.) below the oxidation temperature, or within 20° F. (11° C.) below the oxidation temperature, or within 10° F. (6° C.) below the oxidation temperature. When the porous material is heated by the oxidation of fuel within the body of porous material, some of the heat can be transferred by thermal conduction and radiation through the solid porous material. Although the cooler gas mixture flows into the body of porous material and thus can remove some of the heat from the porous material, the thermal conduction and radiation can be sufficient to maintain the body of porous material at the oxidation temperature. It is noted that the entire body of porous material may not be at a single uniform temperature. In some examples, the temperature of the porous material can increase in a downstream direction. However, in some examples, all of the porous material can be maintained at a temperature that will support oxidation of the fuel gas. Therefore, oxidation can begin upon contact of the gas mixture with the porous material in the oxidation chamber.

As mentioned above, the hot oxidation product gases produced in the oxidation chamber can be utilized for providing heat to another process unit. The heat can be utilized anywhere where heat at the particular oxidation temperature is desired. In some examples, the heat can be utilized in an oil refining process, an oil shale pyrolysis process, or another industrial process. In certain examples, the oxidation product stream can flow through a heat exchanger to transfer heat to another process.

The carbon dioxide produced by the oxidation can also be utilized in various ways. As explained above, carbon dioxide can be recycled to dilute the fuel gas in the gas mixture entering the oxidation chamber. However, there can be excess carbon dioxide produced by the oxidation in addition to the carbon dioxide that is recycled. The excess carbon dioxide can be sequestered, stored, sold, or used in another process. In some examples, the oxidation products stream can include substantially only carbon dioxide and water vapor. This gas can be sequestered in any suitable sequestration site, such as empty oil reservoirs, underground brine reservoirs, or others. The oxidation product stream can also be used for enhanced oil and gas recovery, by injecting the oxidation product into an oil or gas field. In some examples, the carbon dioxide can be purified and stored to be sold or used elsewhere. If the oxidation product stream is made up of only carbon dioxide and water vapor, then the purification of the carbon dioxide can be done easily by simply condensing the water vapor. In other examples, the oxidation product stream can be fuel-rich, and contain combustible components in addition to the carbon dioxide. In some examples, a portion of the oxidation product stream can be used as fuel for another process, such as in a powder generator.

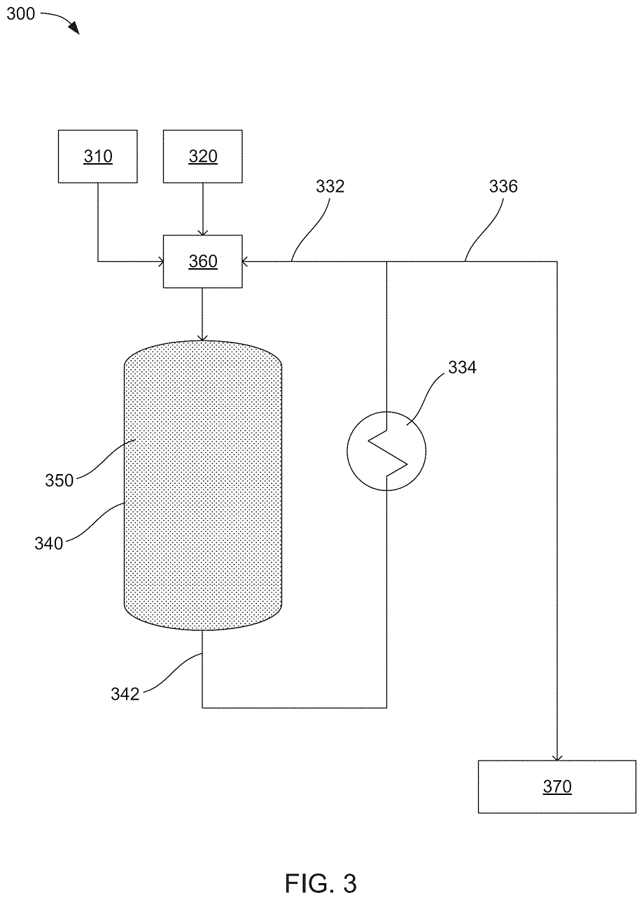

FIG. 3 shows another example homogeneous charge continuous oxidation system for generating heat 300. This example includes a fuel gas source 310 and an oxygen source 320. In this example, the carbon dioxide source is a recycle stream 332 that provides all the carbon dioxide utilized for diluting the fuel gas and oxygen. These gases are mixed in a mixing chamber 360 and then the gas mixture is injected into the oxidation chamber 340 containing a body of porous material 350. Further, in this example, an oxidation product stream flows from an oxidation product outlet 342 through a heat exchanger 334 that transfers heat from the oxidation product stream to another process (not shown). The oxidation product stream then splits into the recycle stream and a sequestration stream 336. The sequestration stream is directed to a carbon dioxide sequestration site 370. It is noted that in other examples, instead of a sequestration stream, the system can include a stream of excess oxidation products directed to be used in any of the ways described above. For example, the stream of excess oxidation products can be injected into an oil or gas field for enhance oil or gas production, or if the oxidation products are fuel-rich then the excess oxidation products can be used as a fuel in a power generator.

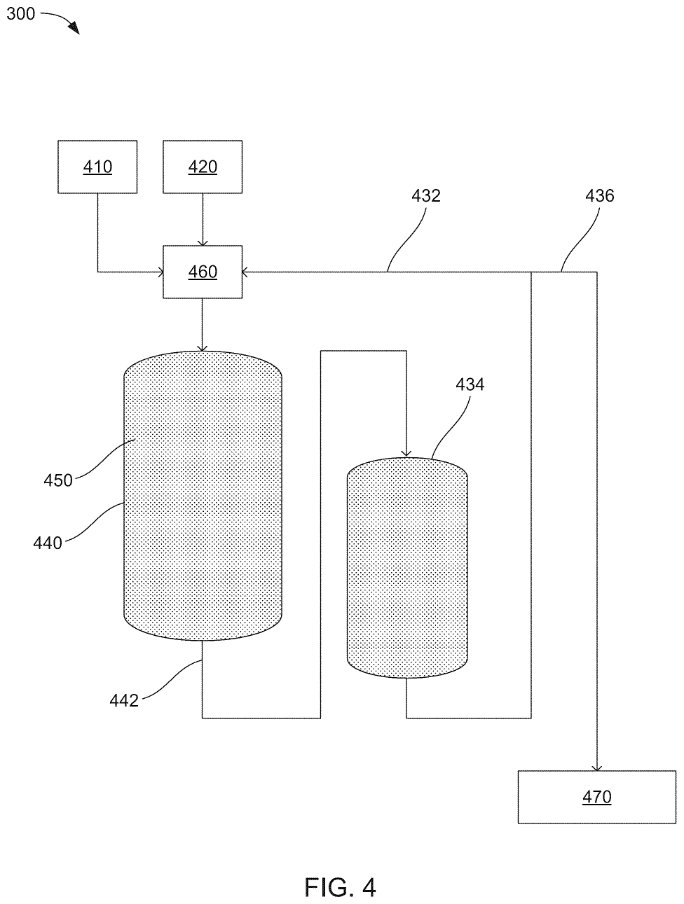

FIG. 4 shows another example system 400 in which an oxidation product stream flows out from an oxidation product outlet 442 in the oxidation chamber 440. The oxidation chamber contains a body of porous material 450 as in previous examples. The oxidation product stream is directed to an oil shale pyrolyzing unit 434. The oil shale pyrolyzing unit includes a vessel filled with crushed fresh oil shale that contains hydrocarbons that can be extracted by heating the oil shale to an extraction temperature. The hot oxidation product stream can provide heat to extract the hydrocarbons from the oil shale. In some examples, the oxidation product stream can transfer heat through a closed-loop heat transfer system, such as closed pipes that pass through the oil shale or a closed jacket around the vessel filled with oil shale. The oxidation product stream can then be split into a recycle stream 432 and a sequestration stream 436. The sequestration stream can be directed to a sequestration site 470. However, in other examples, the hot oxidation product stream can transfer heat to the oil shale in an open-loop system, in which the hot oxidation product gas is injected directly into the vessel filled with oil shale. In this case, hydrocarbons can be liberated from the oil shale and collected as liquids and/or gases. A mixed stream can flow out of the vessel, the mixed stream containing the oxidation products and hydrocarbons extracted from the oil shale. In some examples, a portion of this stream can be recycled to the oxidation chamber to provide the carbon dioxide and a portion (or all) of the fuel gas used in the oxidation chamber. Additional fuel gas can be provided from a separate fuel gas source 410, and the fuel can be mixed with oxygen from an oxygen source 420 in a mixing chamber 460. Another portion of the mixed stream can be collected and hydrocarbon products produced from the oil shale can be separated from carbon dioxide. The hydrocarbon products can be stored or used as fuel, and the carbon dioxide can be sequestered or used as described above.

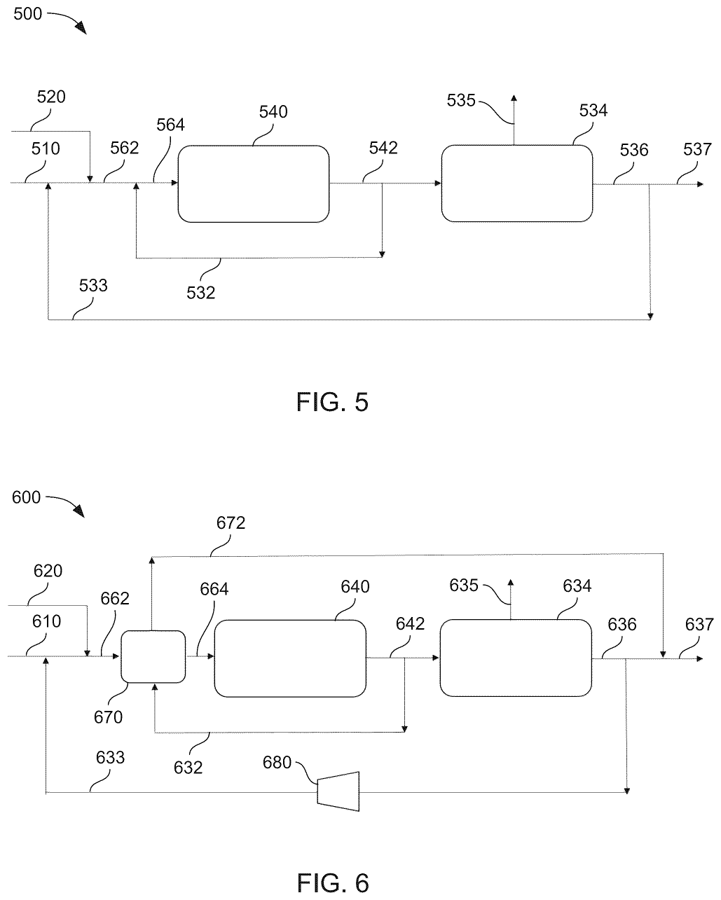

Another example system 500 is shown in FIG. 5. This system includes an HCCO burner 540 (oxidation chamber). Hot oxidation products (hot HCCO burner exhaust) flow out of the HCCO burner through a hot HCCO burner exhaust stream 542 to transfer heat to a process at the heat transfer 534 by heat to process stream 535. A portion of the hot oxidation products are recycled through a hot burner exhaust recycle stream 532 to be mixed with a cool HCCO fuel gas and oxygen mixture in fuel/oxygen stream 562, forming a warm HCCO burner fuel gas mixture stream 564, which is a warm fuel gas/oxygen/oxidation product mixture. This gas mixture fuels the HCCO burner. The sources of the gases in the gas mixture include a fuel gas stream 510, an oxygen stream 520, and a cool burner exhaust recycle stream 533 that recycles a portion of cool oxidation products after the heat has been removed by the heat transfer to process. After the heat has been transferred from the hot HCCO burner exhaust stream, the now cooler oxidation products flow out through a cool HCCO burner exhaust stream 536, where a portion is recycled as the cool burner exhaust recycle stream, and the remainder is in an HCCO flue gas stream 537, which can be exhausted, stored, sequestered, etc.

FIG. 6 shows a different example system 600. This system is similar to the system of FIG. 5, but the system includes a HCCO feed preheat exchanger 670 to preheat the gas mixture flowing through the HCCO burner fuel gas mixture stream 664 into the HCCO burner 640. Oxidation products flow out of the HCCO burner (oxidation chamber) as a hot HCCO burner exhaust stream 642. A portion of this stream is recycled through a preheat hot burner exhaust recycle stream 632 to the preheat exchanger, where heat is transferred from the hot oxidation products to the gas mixture heading into the HCCO burner. The oxidation products, now cooler, flow through a preheat cool burner exhaust stream 672 to be added into the final flue gas stream 637. As in the previous example, the gases originate with a fuel gas stream 610, an oxygen stream 620, and a cool burner exhaust recycle stream 633 that includes oxidation products. The cool burner exhaust recycle stream is blown by blower 680 to inject the oxidation products into the fuel gas stream, which is mixed with the oxygen stream to form the cool HCCO fuel/oxygen mixture stream 662. Heat is transferred to another process at heat transfer 634 by heat to process stream 635. Cool oxidation products flow out of this heat transfer as cool HCCO burner exhaust stream 636, and a portion of this stream is recycled through the cool burner exhaust recycle stream.

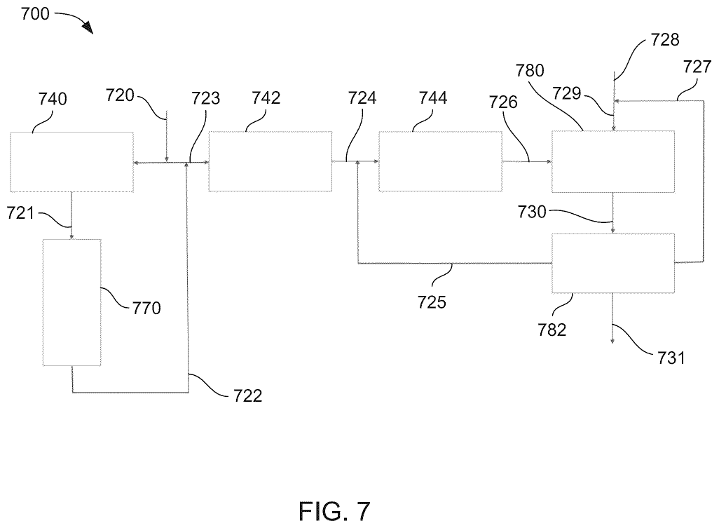

FIG. 7 shows another example system 700. An HCCO burner 740 (oxidation chamber) is fueled by a gas mixture that includes fresh fuel gas (not shown) and a mixture of oxygen 720 and process gas stream 722, which can contain unburned fuel gas and oxidation products from the HCCO burner. The exhaust from the HCCO burner flows through a HCCO burner exhaust stream 721 to a process 770 where heat is transferred to the process from the hot exhaust. This system also includes a downstream power generator 780 that generates powder by internal combustion of unburned fuel in the HCCO burner exhaust. A portion of the exhaust flows through a net process gas stream 723 to a low pressure surge tank 742. The exhaust the flows through a first stage fuel mix stream 724, where it mixes with carbon dioxide from a CO₂ to fuel mix stream 725. The mixture then flows into a high pressure surge tank 744, after which the mixture flows to the internal combustion engine power generator. Additional oxygen flows to the internal combustion engine power generator through an O₂ stream 728, and the oxygen is mixed with carbon dioxide from a CO₂ to oxygen mix stream 727 to make an oxygen/carbon dioxide mixture in a O₂/CO₂ mix stream 729. The exhaust from the internal combustion engine flows through an internal combustion engine exhaust stream 730 to a carbon dioxide drying, cleaning, and compression system 782. This provides carbon dioxide for use or sequestration in CO₂ sequestration stream 731, and also sends recycle carbon dioxide through the CO₂ to fuel mix stream and the CO₂ to oxygen mix stream.

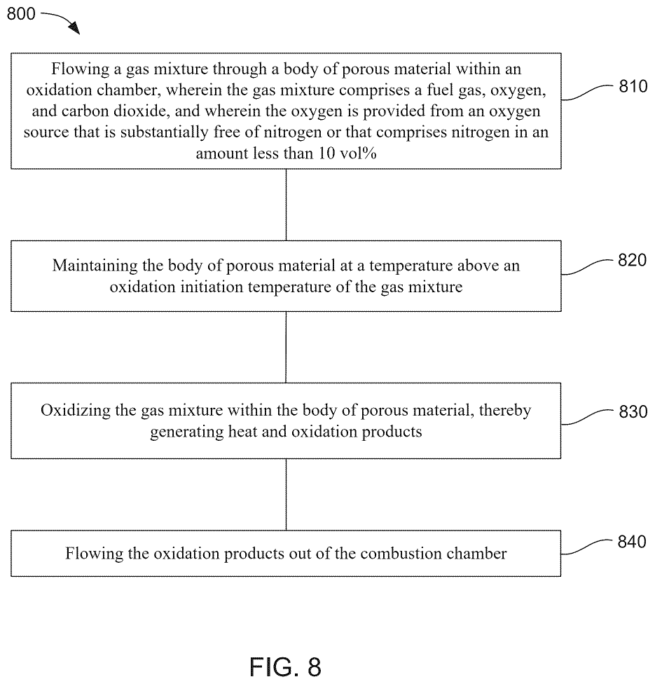

The present disclosure also describes methods for generating heat. FIG. 8 is a flowchart illustrating one example homogeneous charge continuous oxidation method for generating heat 800. The method includes: flowing a gas mixture through a body of porous material within an oxidation chamber, wherein the gas mixture comprises a fuel gas, oxygen, and carbon dioxide, and wherein the gas mixture is substantially free of nitrogen or that comprises nitrogen in an amount less than 10 vol % 810; maintaining the body of porous material at a temperature above an oxidation initiation temperature of the gas mixture 820; oxidizing the gas mixture within the body of porous material, thereby generating heat and oxidation products 830; and flowing the oxidation products out of the oxidation chamber 840. In further examples, methods can include any of the features described above with respect to the homogeneous charge continuous oxidation systems for generating heat.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A homogeneous charge continuous oxidation system for generating heat, comprising:
a fuel gas source;
an oxygen source comprising oxygen gas that is substantially free of nitrogen or that comprises nitrogen in an amount less than 10 vol %;
a carbon dioxide source;
an oxidation chamber comprising an oxidation product outlet and at least one inlet connected to the fuel gas source, the oxygen source, and the carbon dioxide source to receive a gas mixture of fuel gas, oxygen, and carbon dioxide; and
a body of porous material within the oxidation chamber and positioned in a flow path of the gas mixture between the at least one inlet and the oxidation product outlet such that oxidation occurs within the body of porous material.

2. The system of claim 1, wherein a flow of fuel gas, a flow of oxygen, and a flow of carbon dioxide are independently controllable.

3. The system of claim 1, wherein the fuel gas is substantially free of nitrogen compounds.

4. The system of claim 1, wherein the fuel gas comprises natural gas, methane, hydrogen, hydrocarbons produced from oil shale, or a combination thereof.

5. The system of claim 1, wherein the oxygen source comprises an oxygen concentrator configured to separate oxygen from air.

6. The system of claim 1, wherein the oxygen gas is substantially free of nitrogen.

7. The system of claim 1, further comprising a carbon dioxide recycle stream connected to the oxidation product outlet, wherein the carbon dioxide source comprises recycled carbon dioxide produced from oxidation in the oxidation chamber and recycled through the recycle stream.

8. The system of claim 1, further comprising a carbon dioxide sequestration stream connected to the oxidation product outlet and configured to sequester carbon dioxide produced by the oxidation.

9. The system of claim 1, further comprising a preheater configured to preheat at least one of the fuel gas, oxygen, and carbon dioxide upstream of the body of porous material.

10. The system of claim 1, further comprising a gas mixing chamber connected downstream of the fuel gas source, oxygen source, and carbon dioxide source, and upstream of the oxidation chamber, configured to prepare a homogeneous mixture of fuel gas, oxygen, and carbon dioxide before the gas mixture flows into the oxidation chamber.

11. The system of claim 1, wherein the porous material substantially fills the oxidation chamber.

12. The system of claim 1, wherein the porous material comprises a loose particulate material having an average particle size from about 1 mm to about 20 cm.

13. The system of claim 1, wherein the porous material comprises spent oil shale, rock, alumina beads, metal beads, metal balls, zeolite, ceramic, structured packing, metal screen, ceramic screen, baffles, mesh, or a combination thereof.

14. The system of claim 1, further comprising a heat exchanger connected downstream to the oxidation product outlet, the heat exchanger providing heat to an industrial process.

15. The system of claim 1, further comprising an oil shale pyrolyzing unit connected downstream to the oxidation product outlet, wherein the oxidation products provide heat to pyrolyze oil shale.

16. A homogeneous charge continuous oxidation method for generating heat, comprising:
flowing a gas mixture through a body of porous material within an oxidation chamber, wherein the gas mixture comprises a fuel gas, oxygen, and carbon dioxide, and wherein the oxygen is provided from an oxygen source that is substantially free of nitrogen or that comprises nitrogen in an amount less than 10 vol %;
maintaining the body of porous material at a temperature above an oxidation initiation temperature of the gas mixture;
oxidizing of the gas mixture within the body of porous material, thereby generating heat and oxidation products; and
flowing the oxidation products out of the oxidation chamber.

17. The method of claim 16, further comprising independently controlling a concentration of fuel gas, oxygen, and carbon dioxide in the gas mixture.

18. The method of claim 16, wherein the fuel gas comprises natural gas, methane, hydrogen, hydrocarbons produced from oil shale, or a combination thereof.

19. The method of claim 16, further comprising separating the oxygen from air and mixing the oxygen with the fuel gas and the carbon dioxide.

20. The method of claim 16, wherein the oxygen is substantially free of nitrogen.

21. The method of claim 16, wherein the carbon dioxide comprises recycled carbon dioxide produced from oxidation in the oxidation chamber.

22. The method of claim 16, wherein the gas mixture is fuel-rich.

23. The method of claim 22, wherein the fuel gas comprises recycled unburned fuel gas from the oxidation chamber.

24. The method of claim 16, further comprising sequestering carbon dioxide from the oxidation products.

25. The method of claim 16, further comprising preheating the gas mixture before the gas mixture contacts the body of porous material.

26. The method of claim 25, wherein the gas mixture is preheated to a preheat temperature within 50° F. (28° C.) of an oxidation initiation temperature of the gas mixture.

27. The method of claim 16, further comprising preparing the gas mixture by mixing the fuel gas, oxygen, and carbon dioxide in a gas mixing chamber that is upstream of the oxidation chamber.

28. The method of claim 16, wherein the gas mixture is prepared in the oxidation chamber by flowing the fuel gas, oxygen, and carbon dioxide into the oxidation chamber as multiple separate streams and then mixing the fuel gas, oxygen, and carbon dioxide inside the oxidation chamber.

29. The method of claim 16, wherein the porous material substantially fills the oxidation chamber.

30. The method of claim 16, wherein the porous material comprises a loose particulate material having an average particle size from about 1 mm to about 20 cm.

31. The method of claim 16, wherein the porous material comprises spent oil shale, rock, alumina beads, metal beads, metal balls, zeolite, ceramic, structured packing, metal screen, ceramic screen, baffles, mesh, or a combination thereof.

32. The method of claim 16, further comprising providing heat from the oxidation products to an industrial process connected downstream of the oxidation chamber.

33. The method of claim 16, further comprising pyrolyzing oil shale using heat from the oxidation products.

34. The method of claim 16, further comprising controlling a temperature of oxidation in the oxidation chamber by adjusting a concentration of carbon dioxide in the gas mixture.

35. The method of claim 16, wherein an oxidation temperature in the oxidation chamber is from about 700° F. (371° C.) to about 3,000° F. (1649° C.).

36. The method of claim 16, wherein the gas mixture comprises oxygen at a concentration from 0.1 vol % to 10 vol %, fuel gas at a concentration from 5 vol % to 70 vol %, and carbon dioxide at a concentration from 25 vol % to 90 vol %.
